(19) United States
(12) Patent Application Publication
(10) Pub. No.: US 2021/0024730 A1
(43) Pub. Date: Jan. 28, 2021

(54) RELAY BOX HOUSING AND RELAY BOX

(71) Applicants: ASAHI KASEI KABUSHIKI KAISHA, Tokyo (JP); Asahi Kasei Plastics North America, Inc., Fowlerville, MI (US)

(72) Inventors: Nozomi INAGAKI, Tokyo (JP); Nihir BHUVA, Fowlerville, MI (US)

(73) Assignees: ASAHI KASEI KABUSHIKI KAISHA, Tokyo (JP); Asahi Kasei Plastics North America, Inc., Fowlerville, MI (US)

(21) Appl. No.: 16/517,688

(22) Filed: Jul. 22, 2019

(51) Int. Cl. C08L 23/12; H01H 45/02

(52) U.S. Cl. CPC C08L 23/12; H01H 45/02; C08L 2203/20; B29C 45/0001; C08L 2205/12; C08L 2207/02; C08L 2205/03

(57) ABSTRACT

Provided is a relay box housing obtained by molding a resin composition containing (a) a polypropylene resin, (b) a polyphenylene ether resin, and (c) a hydrogenated block copolymer. The resin composition has a deflection temperature under load of 100° C. or higher and a ratio of the storage elastic modulus G′_{A} to G′_{B}, expressed as G′_{A}/G′_{B}, of 0.9 to 1.5. Multipurpose test specimens A and B are obtained from the resin composition with an injection molding method with a first multipurpose test specimen A immersed in water under predetermined conditions and a second multipurpose test specimen B not immersed. Storage elastic modulus measurement is performed on each of the test specimens A and B at 50° C. in a tensile mode to obtain the storage elastic moduli G′_{A} and G′_{B}.

### TECHNICAL FIELD

This disclosure relates to a relay box housing and a relay box.

### BACKGROUND

Polyamide resins may be used to provide heat resistance for relay blocks set in the hood or interior of motor vehicles and for relay box housings that house the relay blocks. However, polyamide absorbs moisture in the air, causing problems of dimensional change and physical property decrease. For this reason, it has been replaced by a polyamide/polyphenylene ether alloy in which the proportion of water-absorbing polymer is reduced.

Motor vehicles may be made of a composition excellent in terms of moldability, mechanical strength, heat resistance, weather resistance and recyclability by using polyamide 6,6, polyamide 6, modified polyphenylene ether, and a metal salt of montanic acid, (and polypropylene).

In addition, a relay box for motor vehicles may be made of a composition excellent in terms of fluidity, mold releasability, mechanical strength, heat resistance, weather resistance and recyclability by using polyamide 6,6, polyamide 6, modified polyphenylene ether, A-B-A type block copolymer, polypropylene, ethylene-a-olefin copolymer, and a metal salt of montanic acid.

### SUMMARY

In recent years, demand for hybrid vehicles, electric vehicles and fuel cell vehicles in place of conventional internal combustion vehicles has increased, and it is considered that sales of these environmentally friendly vehicles will grow significantly in the future due to the increase in environmental concerns in various countries around the world. These environmentally friendly vehicles are equipped with more electronic control components than internal combustion vehicles. As a result, a relay block that houses the electronic circuit and the accompanying relay box housing tend to become larger in size. Furthermore, the structures tend to become more complicated.

For this reason, it has been difficult to sufficiently meet the market demand despite the use of a polyamide/polyphenylene ether alloy which is said to be less influenced by water absorption than a polyamide resin. For example, a relay block using a polyamide/polyphenylene ether alloy having high fluidity and low dimensional change upon water absorption which are equal to or better than a certain level may be desired. However, the required quality level may change in future because of the complexity of the structure and other reasons, and in order to cope with this change, it is desired to improve the performance in durability against vibration in actual use in addition to the physical properties upon the absorption of moisture in the air. Polypropylene is excellent in molding processability, oil resistance, acid resistance, alkali resistance and other properties, and its water absorption is also extremely low. However, polypropylene is a crystalline resin, and may cause a problem with regards to warpage of the shape of a molded product. Therefore, there remains the problem that in order to prevent warpage, the molded shape of the relay box housing would be necessarily complicated.

It could thus be helpful to provide a relay box housing that has excellent durability against vibration during actual use while maintaining the heat resistance required for a relay box housing, as well as a relay box.

As a result of intensive study on solving the aforementioned problems, we have discovered that a relay box housing obtained by molding a resin composition containing a specific polypropylene resin, a specific polyphenylene ether, and a hydrogenated block copolymer having a specific structure can solve the problems advantageously.

We thus provide the following.

[1] A relay box housing obtained by molding a resin composition, wherein

the resin composition comprises:
(a) a polypropylene resin,
(b) a polyphenylene ether resin, and
(c) a hydrogenated block copolymer in which at least a part of a block copolymer comprising a polymer block A and a polymer block B is hydrogenated, where the polymer block A is a block mainly composed of a vinyl aromatic compound, and the polymer block B is a block mainly composed of a conjugated diene compound having a total content of 1,2-vinyl bonds and 3,4-vinyl bonds of 30% to 90%, wherein the resin composition has a deflection temperature under load of 100° C. or higher at 0.45 MPa as measured according to ISO 75, and

the resin composition has a ratio of the storage elastic modulus G′_{A} to G′_{B}, expressed as G′_{A}/G′_{B}, of 0.9 to 1.5, where G′_{A} and G′_{B} are storage elastic moduli of test specimens A and B, respectively, obtained by processing multipurpose test specimens as defined in ISO 294-1, which are obtained from the resin composition with an injection molding method, under a set of conditions, storage elastic modulus measurement is performed on each of the test specimens A and B at 50° C. in a tensile mode to obtain the storage elastic moduli G′_{A} and G′_{B}, and the set of conditions are as follows:

test specimen A: a first multipurpose test specimen is annealed at 80° C. for 24 hours after injection molding and immersed in water at 70° C. for 12 hours after annealing, then the first multipurpose test specimen after immersing is left to stand in an environment of 23° C. and 50% RH for 672 hours, the first multipurpose test specimen, after standing, is used as the test specimen A, and the storage elastic modulus G′_{A} is measured at 50° C. in a tensile mode; and

test specimen B: a second multipurpose test specimen is annealed at 80° C. for 24 hours after injection molding, the test second multipurpose specimen, after annealing, is used as the test specimen B, and the storage elastic modulus G′_{B} is measured at 50° C. in a tensile mode.

[2] The relay box housing according to [1], wherein a crystallization peak area of the resin composition measured by a differential scanning calorimeter (DSC) is 55 J/g or more.

[3] The relay box housing according to [1], wherein the resin composition has a deflection temperature under load of 110° C. or higher at 0.45 MPa as measured according to ISO 75.

[4] The relay box housing according to [2], wherein the resin composition has a deflection temperature under load of 110° C. or higher at 0.45 MPa as measured according to ISO 75.

[5] The relay box housing according to [1], wherein the component (c) has a polystyrene-equivalent number-average molecular weight Mn of 150,000 or more as measured by gel permeation chromatography (GPC).

[6] The relay box housing according to [1], wherein the resin composition has a morphology in which the component (a) is in a continuous phase and the component (b) is in a dispersed phase, and an average major axis of the dispersed phase of the component (b) is 1 μm or less.

[7] The relay box housing according to [2], wherein the resin composition has a morphology in which the component (a) is in a continuous phase and the component (b) is in a dispersed phase, and an average major axis of the dispersed phase of the component (b) is 1 μm or less.

[8] The relay box housing according to [4], wherein the resin composition has a morphology in which the component (a) is in a continuous phase and the component (b) is in a dispersed phase, and an average major axis of the dispersed phase of the component (b) is 1 μm or less.

[9] The relay box housing according to [1], wherein the resin composition further comprises (d) fibrous inorganic filler.

[10] The relay box housing according to [1], comprising a portion with a thickness of 0.5 mm to 5.0 mm.

[11] A relay box comprising the relay box housing according to [1] and a relay block housed inside the relay box housing.

According to the present disclosure, it is possible to provide a relay box housing that has excellent durability against vibration in actual use while maintaining the heat resistance required for a relay box housing, as well as a relay box.

### BRIEF DESCRIPTION OF THE DRAWINGS

In the accompanying drawings:

FIG. 1 illustrates a molded product (a substitute for a relay box housing) prepared to evaluate the dimensional change upon water absorption for the resin compositions of Examples and Comparative Examples;

FIG. 2 is a view of the molded product illustrated in FIG. 1 from the reverse side;

FIG. 3 illustrates a flat plate prepared to evaluate the warpage of the molded product and measurement positions in the flat plate for the resin compositions of Examples and Comparative Examples; and

FIG. 4 illustrates the configuration of a twin-screw extruder used to produce the resin compositions of Examples and Comparative Examples and the production conditions.

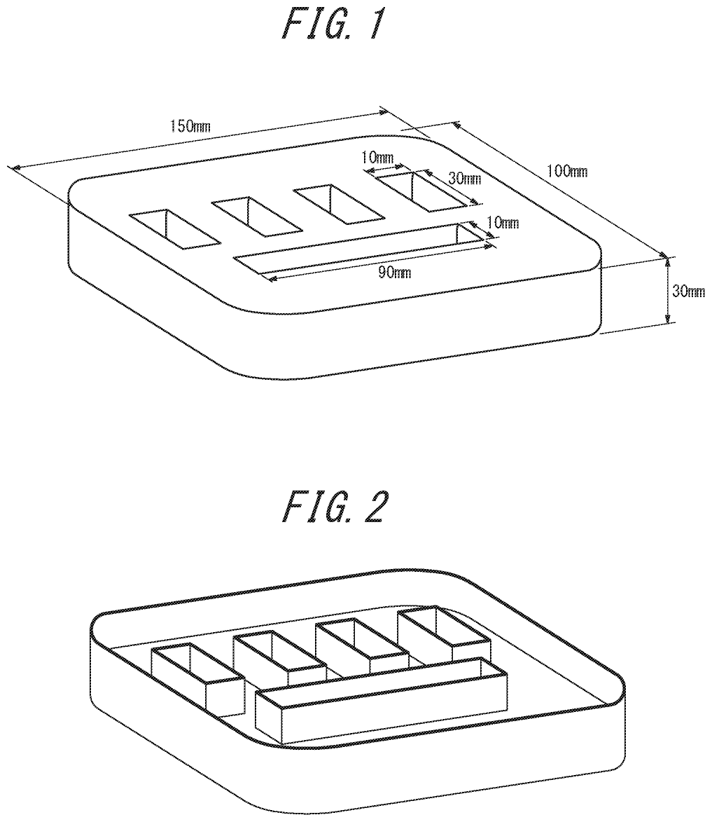

### DETAILED DESCRIPTION

The following provides a detailed description of an embodiment of the present disclosure (hereinafter, also referred to as “present embodiment”). However, the present disclosure is not limited to the following embodiment and may be implemented with various alterations which are within the essential scope thereof.

(Relay Box Housing)

The relay box housing of the present embodiment is obtained by molding a resin composition. The resin composition contains (a) a polypropylene resin, (b) a polyphenylene ether resin, and (c) a hydrogenated block copolymer in which at least a part of a block copolymer containing a polymer block A and a polymer block B is hydrogenated. The polymer block A is a block mainly composed of a vinyl aromatic compound, and the polymer block B is a block mainly composed of a conjugated diene compound having a total content of 1,2-vinyl bonds and 3,4-vinyl bonds of 30% to 90%. In addition, the resin composition has a deflection temperature under load of 100° C. or higher at 0.45 MPa as measured according to ISO 75. Furthermore, the resin composition has a ratio of the storage elastic modulus G′A to G′B (G′A/G′B) is 0.9 to 1.5. G′A and G′B are storage elastic moduli of test specimens A and B, respectively, obtained by processing multipurpose test specimens as defined in ISO 294-1, which are obtained from the resin composition with an injection molding method under the following conditions to obtain test specimens A and B. Storage elastic modulus measurement is performed on each of the test specimens A and B at 50° C. in a tensile mode to obtain the storage elastic moduli G′_{A} and G′_{B}. The set of conditions are as follows:

Test specimen A: a first multipurpose test specimen is annealed at 80° C. for 24 hours after injection molding and immersed in water at 70° C. for 12 hours after annealing, and then the first multipurpose test specimen after immersing is left to stand for 672 hours in an environment of 23° C. and 50% RH. The first multipurpose test specimen, after standing, is used as the test specimen A, and the storage elastic modulus G′_{A} is measured at 50° C. in a tensile mode. Test specimen B: a second multipurpose test specimen is annealed at 80° C. for 24 hours after injection molding. The second multipurpose test specimen, after annealing, is used as the test specimen B, and the storage elastic modulus G′_{B} is measured at 50° C. in a tensile mode.

According to the relay box housing of the present embodiment, it is possible to improve the durability against vibration during actual use while maintaining the heat resistance required for a relay box housing.

Hereinafter, “(a) a polypropylene resin” and “(b) a polyphenylene ether resin” are also referred to as “component (a)” and “component (b)”, respectively. In addition, “(c) a hydrogenated block copolymer in which at least a part of a block copolymer containing a polymer block A and a polymer block B is hydrogenated, where the polymer block A is a block mainly composed of a vinyl aromatic compound and the polymer block B is mainly composed of a conjugated diene compound having a total content of 1,2-vinyl bonds and 3,4-vinyl bonds of 30% to 90%” is also referred to as “(c) hydrogenated block copolymer” or “component (c)”.

The relay box housing of the present embodiment can be used as a relay box by housing a relay block. Specifically, a relay box includes a relay box housing and a relay block housed (mounted) inside the housing, and can usually be used by setting a relay or a fuse in the relay block. Therefore, a relay box housing may be a housing for supporting and covering a relay block. When the relay box has a lid, the relay box housing also includes a lid. The application of the relay box is not particularly limited. For example, the relay box can be used for motor vehicles, and suitably used for hybrid vehicles, electric vehicles, and fuel cell vehicles.

The relay box housing of the present embodiment is not particularly limited, and may have, for example, a plate-like wall and a bottom with a thickness of 0.5 mm to 5 mm. In addition, the relay box housing may have a height from the bottom to the opening of the housing of 3 mm to 50 mm, and a dimension of 10 mm to 200 mm for one side in a plan view of the housing.

(Resin Composition)

The resin composition of the present embodiment contains (a) a polypropylene resin, (b) a polyphenylene ether resin, and (c) a hydrogenated block copolymer. In addition, the resin composition of the present embodiment can further optionally contain (d) fibrous inorganic filler (hereinafter, also referred to as “component (d)”), (e) a thermoplastic resin other than the components (a) and (b) (hereinafter, also referred to as “component (e)”), and (x) an additive other than the components (a) to (e) (hereinafter, also referred to as “component (x)”).

The following describes the components of the resin composition of the present embodiment.

(a) Polypropylene Resin

The (a) polypropylene resin used in the present embodiment is not particularly limited, and examples thereof include polypropylene, modified polypropylene, and a mixture of both. The component (a) may be used alone or in a combination of two or more resins.

The weight-average molecular weight (Mw) of the component (a) is preferably 400,000 or more, more preferably 700,000 or more, and particularly preferably 750,000 or more. In addition, the weight-average molecular weight (Mw) is preferably 1,500,000 or less, and more preferably 1,300,000 or less. When the weight-average molecular weight (Mw) is in the aforementioned ranges, it is possible to suppress the drawdown during combustion and to improve the balance between fluidity and mechanical strength for the resin composition.

The weight-average molecular weight (Mw) can be determined by a conventionally known method using gel permeation chromatography (hereinafter also referred to as “GPC”). The moving phase of the measurement is not particularly limited, and may use, for example, o-dichlorobenzene. The standard substance is not particularly limited, and may use, for example, polystyrene.

Polypropylene

The polypropylene is not particularly limited, and examples thereof include a homopolymer and/or a copolymer structure having propylene as a repeating unit. Specifically, the polypropylene is preferably a crystalline propylene homopolymer, a crystalline propylene-ethylene block copolymer, or a mixture of a crystalline propylene homopolymer and a crystalline propylene-ethylene block copolymer.

The crystalline propylene-ethylene block copolymer is not particularly limited, and examples thereof include those having a crystalline propylene homopolymer moiety and a propylene-ethylene random copolymer moiety.

The melt flow rate (hereinafter, also referred to as “MFR”) of the polypropylene is preferably 0.1 g/10 min or more, and more preferably 0.3 g/10 min or more. In addition, the MFR is preferably 150 g/10 min or less, more preferably 120 g/10 min or less, and particularly preferably 100 g/10 min or less. When the MFR is in the aforementioned ranges, it is possible to suppress the drawdown during combustion and to improve the balance between fluidity and mechanical strength for the resin composition.

The MFR can be measured under the conditions of a temperature of 230° C. and a load of 2.16 kg according to ISO 1133.

The method of producing the polypropylene is not particularly limited, and may be any known method.

Specific examples of the method of producing the polypropylene include a method of polymerizing propylene under the conditions of a temperature of 0° C. to 100° C. and a pressure of 3 atm to 100 atm in the presence of a polymerization catalyst composition containing an alkylaluminum compound and a titanium trichloride catalyst or a titanium halide catalyst or the like supported on a carrier such as magnesium chloride.

In the above method, a chain transfer agent such as hydrogen may be added to adjust the molecular weight of the polymer.

Furthermore, in the above method, the polymerization system can further include an electron-donating compound as an internal donor component or an external donor component in addition to the aforementioned polymerization catalyst composition, to enhance the isotacticity of the resulting polypropylene and the polymerization activity of the polymerization system. The electron-donating compound is not particularly limited, and any known one may be used. Specific examples of the electron-donating compound include an ester compound such as ε-caprolactone, methyl methacrylate, ethyl benzoate, and methyl toluate; a phosphite ester such as triphenyl phosphite and tributyl phosphite; a phosphoric acid derivative such as hexamethylphosphoric triamide; an alkoxy ester compound; an aromatic monocarboxylic acid ester; an aromatic alkylalkoxysilane; an aliphatic hydrocarbon alkoxysilane; various ether compounds; various alcohols; and various phenols.

The polymerization in the aforementioned production method may be either batch polymerization or continuous polymerization. The polymerization method may be a solution polymerization or a slurry polymerization method using a solvent such as butane, pentane, hexane, heptane or octane, or may be a bulk polymerization method in monomers or a gas phase polymerization method in gaseous polymers without solvent.

Among the polypropylenes, the method of producing the crystalline propylene-ethylene block copolymer is not particularly limited. Examples thereof include a method including a first step of obtaining a crystalline propylene homopolymer moiety and a second step of copolymerizing the crystalline propylene homopolymer moiety with ethylene and an optionally added α-olefin to obtain a propylene-ethylene block copolymer moiety bonded to the crystalline propylene homopolymer moiety. The α-olefin is not particularly limited, and examples thereof include propylene, 1-butene, and 1-hexene.

Modified Polypropylene

The modified polypropylene is not particularly limited, and examples thereof include those obtained by grafting or adding an α,62 -unsaturated carboxylic acid or a derivative thereof (e.g., an acid anhydride, an ester, etc.) to the aforementioned polypropylene. The proportion of mass increase because of the grafting or adding is not particularly limited. It is preferably 0.01% by mass or more and 10% by mass or less, more preferably 7% by mass or less, and particularly preferably 5% by mass or less, with respect to 100% by mass of the modified polypropylene.

The method of producing the modified polypropylene is not particularly limited, and examples thereof include a method of reacting the aforementioned polypropylene with an α,β-unsaturated carboxylic acid or a derivative thereof at 30° C. to 350° C. in a molten, solution or slurry state in the presence or absence of a radical generator.

When the (a) polypropylene resin used in the present embodiment is a mixture of polypropylene and modified polypropylene, the mixing ratio of the polypropylene and the modified polypropylene is not particularly limited and may be in any ratio.

(b) Polyphenylene Ether Resin

The (b) polyphenylene ether resin used in the present embodiment is not particularly limited, and examples thereof include polyphenylene ether, modified polyphenylene ether, and a mixture of both. The component (b) may be used alone or in a combination of two or more.

The reduced viscosity of the component (b) is preferably 0.25 dL/g or more and more preferably 0.28 dL/g or more. In addition, the reduced viscosity is preferably 0.60 dL/g or less, more preferably 0.55 dL/g or less, and particularly preferably 0.50 dL/g or less. When the reduced viscosity is in the aforementioned ranges, the flame retardance of the resin composition can be further improved. The reduced viscosity can be controlled by the polymerization time and the catalyst amount.

The reduced viscosity can be measured at a temperature of 30° C. using a chloroform solution of ηsp/c: 0.5 g/dL. Specifically, it can be measured with the method described in the following EXAMPLES section.

Polyphenylene Ether

The polyphenylene ether is not particularly limited, and examples thereof include a homopolymer composed of a repeating unit structure represented by the following formula (1) and/or a copolymer having a repeating unit structure represented by the following formula (1):

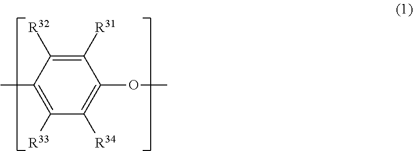

where R³¹, R³², R³³ and R³⁴ each independently represent a hydrogen atom, a halogen atom, or a monovalent group selected from the group consisting of a primary alkyl group having 1 to 7 carbon atoms, a secondary alkyl group having 1 to 7 carbon atoms, a phenyl group, a haloalkyl group, an aminoalkyl group, a hydrocarbonoxy group, and a halohydrocarbonoxy group in which at least two carbon atoms separate a halogen atom from an oxygen atom.

The polyphenylene ether is not particularly limited, and may be any known one. Specific examples of the polyphenylene ether include a homopolymer such as poly (2,6-dimethyl-1,4-phenylene ether), poly (2-methyl-6-ethyl-1,4-phenylene ether), poly (2-methyl-6-phenyl-1,4-phenylene ether), and poly (2,6-dichloro-1,4-phenylene ether); and a copolymer such as a copolymer of 2,6-dimethylphenol and other phenols such as 2,3,6-trimethylphenol and 2-methyl-6-butylphenol. The polyphenylene ether is preferably poly (2,6-dimethyl-1,4-phenylene ether) or a copolymer of 2,6-dimethylphenol and 2,3,6-trimethylphenol, and is more preferably poly (2,6-dimethyl-1,4-phenylene ether).

The method of producing the polyphenylene ether is not particularly limited, and may be any conventionally known method. Specific examples of the method of producing the polyphenylene ether include the method described in U.S. Pat. No, 3,306,874 A where polyphenylene ether is produced, for example, by oxidative polymerization of 2,6-xylenol using, for example, a complex of a cuprous salt and an amine as a catalyst, and the methods described in U.S. Pat. Nos. 3,306,875 A, 3,257,357 A, 3,257,358 A, JP S52-17880 B, JP S50-51197 A and JP S63-152628 A. The descriptions of these documents are incorporated herein by reference.

Modified Polyphenylene Ether

The modified polyphenylene ether is not particularly limited, and examples thereof include those obtained by grafting and/or adding a styrene polymer or a derivative thereof to the aforementioned polyphenylene ether. The proportion of mass increase due to the grafting and/or addition of a styrene polymer or a derivative thereof is not particularly limited. It is preferably 0.01% by mass or more and 10% by mass or less, more preferably 7% by mass or less, and particularly preferably 5% by mass or less, with respect to 100% by mass of the modified polyphenylene ether.

The method of producing the modified polyphenylene ether is not particularly limited, and examples thereof include a method of reacting the aforementioned polyphenylene ether with a styrene polymer or a derivative thereof at 80° C. to 350° C. in a molten, solution or slurry state in the presence or absence of a radical generator.

When the (b) polyphenylene ether resin used in the present embodiment is a mixture of polyphenylene ether and modified polyphenylene ether, the mixing ratio of the polyphenylene ether and the modified polyphenylene ether is not particularly limited and may be any ratio.

(c) Hydrogenated Block Copolymer

The (c) hydrogenated block copolymer resin used in the present embodiment is not particularly limited, and examples thereof include an unmodified hydrogenated block copolymer, a modified hydrogenated block copolymer, and a mixture of both. The component (c) may be used alone or in a combination of two or more resins.

The component (c) acts as an impact resistance-imparting agent or an admixture of the aforementioned components (a) and (b).

The (c) hydrogenated block copolymer resin may be a resin obtained by hydrogenating at least a part of a block copolymer containing a polymer block A mainly composed of a vinyl aromatic compound and a polymer block B mainly composed of a conjugated diene compound. Here, the total content of 1,2-vinyl bonds and 3,4-vinyl bonds of the conjugated diene compound in the polymer block B (hereinafter, also referred to as “total vinyl bond content”, which will be described later) is preferably 30% to 99%.

The following describes matters regarding the unmodified and modified hydrogenated block copolymers.

Polymer Block A Mainly Composed of Vinyl Aromatic Compound

The polymer block A mainly composed of a vinyl aromatic compound is not particularly limited, and examples thereof include a homopolymer block of a vinyl aromatic compound, and a copolymer block of a vinyl aromatic compound and a conjugated diene compound.

The polymer block A is “mainly composed of a vinyl aromatic compound” indicates that the content of the vinyl aromatic compound moiety in the polymer block A before hydrogenation is more than 50% by mass. The content is preferably 70% by mass or more and more preferably 80% by mass or more. In addition, the content may be 100% by mass or less.

The vinyl aromatic compound of the polymer block A is not particularly limited, and examples thereof include styrene, α-methylstyrene, vinyltoluene, p-tert-butylstyrene, and diphenylethylene, among which styrene is preferable. The vinyl aromatic compound may be used alone or in a combination of two or more.

The number-average molecular weight (Mn) of the polymer block A is preferably 15,000 or more, more preferably 20,000 or more, and particularly preferably 25,000 or more. In addition, the number-average molecular weight (Mn) is preferably 100,000 or less. When the number-average molecular weight (Mn) is in the aforementioned ranges, the thermal creep resistance of the resin composition can be improved.

The number-average molecular weight (Mn) can be determined by a conventionally known method using GPC (moving bed: chloroform, standard substance: polystyrene). Specifically, the number-average molecular weight (Mn) can be measured with a method described in the following EXAMPLES section.

Polymer Block B Mainly Composed of Conjugated Diene Compound

The polymer block B mainly composed of a conjugated diene compound is not particularly limited, and examples thereof include a homopolymer block of a conjugated diene compound, and a copolymer block of a conjugated diene compound and a vinyl aromatic compound.

The polymer block B is “mainly composed of a conjugated diene compound” indicates that the content of the conjugated diene compound moiety in the polymer block B before hydrogenation is more than 50% by mass. From the viewpoint of enhancing the fluidity of the resin composition, the content is preferably 70% by mass or more and more preferably 80% by mass or more. In addition, the content may be 100% by mass or less.

The conjugated diene compound of the polymer block B is not particularly limited, and examples thereof include butadiene, isoprene, 1,3 -pentadiene, and 2,3-dimethyl-1,3-butadiene. Among the above, butadiene, isoprene, and a combination thereof are preferable, and butadiene is more preferable. The conjugated diene compound may be used alone or in a combination of two or more.

From the viewpoint of improving the compatibility of the polymer block B with the component (a) and suppressing the change in physical properties upon water absorption, the total content of 1,2-vinyl bonds and 3,4-vinyl bonds (the total vinyl bond content) is 30% or more, preferably 45% or more, and more preferably 65% or more, in the microstructure (the bonded form of the conjugated diene compound) of the polymer block B. In addition, the total vinyl bond content is 99% or less, preferably 95% or less, and more preferably 90% or less.

The total content of 1,2-vinyl bonds and 3,4-vinyl bonds (the total vinyl bond content) means the ratio of the total of the 1,2-vinyl bond content and the 3,4-vinyl bond content to the total of the 1,2-vinyl bond content, the 3,4-vinyl bond content and the 1,4-conjugated bond content, in the polymer block B before hydrogenation. The total vinyl bond content can be measured using an infrared spectrophotometer and calculated according to the method described in Analytical Chemistry, Volume 21, No. 8, August, 1949.

The number-average molecular weight (Mn) of the polymer block B is preferably 10,000 or more, more preferably 20,000 or more, and particularly preferably 30,000 or more. In addition, the number-average molecular weight (Mn) is preferably 200,000 or less. When the number-average molecular weight (Mn) is in the aforementioned ranges, it is possible to improve the balance between impact resistance and molding fluidity of the resin composition.

The number-average molecular weight (Mn) can be determined with a conventionally known method using GPC (moving bed: chloroform, standard substance: polystyrene). Specifically, the number-average molecular weight (Mn) can be measured with the method described in the following EXAMPLES section.

The method of synthesizing the block copolymer containing the polymer block A and the polymer block B is not particularly limited, and examples thereof include a known method such as anionic polymerization.

The block structure of the block copolymer of the unmodified and modified hydrogenated block copolymers is not particularly limited. For example, when the polymer block A is represented by “A” and the polymer block B is represented by “B”, the structure of the component (c) may be A-B, A-B-A, B-A-B-A, (A-B-)₄M, A-B-A-B-A, or the like. The (A-B-)₄M may be a reaction residue of a multifunctional coupling agent such as silicon tetrachloride (M=Si) or tin tetrachloride (M=Sn), a residue of an initiator such as a multifunctional organolithium compound, or the like.

The molecular structure of the block copolymer of the unmodified and modified hydrogenated block copolymers is not particularly limited, and may, for example, be linear, branched, radial, or a combination thereof.

In the block copolymer, the distribution of the vinyl aromatic compound in the molecular chain of the polymer block A and the conjugated diene compound in the molecular chain of the polymer block B is not particularly limited, and may, for example, be random, tapered (where the monomer moiety increases or decreases along the molecular chain), partially blocked, or a combination thereof.

When the block copolymer contains a plurality of polymer blocks A or a plurality of polymer blocks B, the plurality of polymer blocks A or the plurality of polymer blocks B may have the same structure or a different structure.

For the entire block copolymer containing the polymer block A and the polymer block B, the content of the vinyl aromatic compound in the block copolymer before hydrogenation is preferably 20% by mass or more and more preferably 30% by mass or more. In addition, the content is preferably 95% by mass or less and more preferably 80% by mass or less. When the content is in the aforementioned ranges, the fluidity, impact resistance and external appearance of the (c) hydrogenated block copolymer can be improved, and weldment occurrence can be reduced.

The content of the vinyl aromatic compound can be measured using a UV spectrophotometer.

The number-average molecular weight (Mn) of the block copolymer before hydrogenation is preferably 50,000 or more, more preferably 70,000 or more, and particularly preferably 80,000 or more. In addition, the number-average molecular weight (Mn) is preferably 1,000,000 or less, more preferably 800,000 or less, and particularly preferably 500,000 or less.

The number-average molecular weight can be determined with a conventionally known method using GPC (moving bed: chloroform, standard substance: polystyrene).

The molecular weight distribution (Mw/Mn) of the block copolymer before hydrogenation is preferably 10 or less, more preferably 8 or less, and particularly preferably 5 or less.

The molecular weight distribution (Mw/Mn) can be calculated by dividing the weight-average molecular weight (Mw), which is determined with a conventionally known method using GPC (moving bed: chloroform, standard substance: polystyrene), by the aforementioned number-average molecular weight (Mn).

The method of hydrogenating the block copolymer is not particularly limited, and examples thereof include a hydrogenation method under the conditions of, for example, a reaction temperature of 0° C. to 200° C. and a hydrogen pressure of 0.1 MPa to 15 MPa, using, for example: (1) a supported heterogeneous hydrogenation catalyst in which a metal such as Ni, Pt, Pd or Ru is carried on carbon, silica, alumina, diatomaceous earth or the like, (2) a so-called Ziegler-type hydrogenation catalyst using an organic acid salt of Ni, Co, Fe, Cr or the like or a transition metal salt such as an acetylacetonate and using a reducing agent such as organic aluminum, and (3) a homogeneous hydrogenation catalyst such as a so-called organic metal complex of, for example, an organic metal compound of Ti, Ru, Rh, Zr or the like.

The hydrogenation ratio to the conjugated diene compound moiety of the polymer block B in the unmodified and modified hydrogenated block copolymers is not particularly limited. From the viewpoint of enhancing the heat resistance of the resin composition, it is preferably 50% or more, more preferably 80% or more, and particularly preferably 90% or more, with respect to the total content of double bonds derived from the conjugated diene compound.

The hydrogenation ratio can be measured using a nuclear magnetic resonance (NMR) apparatus.

The method of producing the unmodified and modified hydrogenated block copolymers is not particularly limited, and may be a known production method. Specific examples of the known production method include the methods described in JP S47-11486 A, JP S49-66743 A, JP S50-75651 A, JP S54-126255 A, JP S56-10542 A, JP S56-62847 A, JP S56-100840 A, JP H02-300218 A, GB 1130770 A, U.S. Pat. Nos. 3,281,383 A, 3,639,517 A, GB 1020720 A, U.S. Pat. Nos. 3,333,024 A, and 4,501,857 A. The descriptions of these documents are incorporated herein by reference.

The following particularly describes matters regarding the modified hydrogenated block copolymer.

(Modified Hydrogenated Block Copolymer)

The modified hydrogenated block copolymer is obtained by grafting or adding an α,β-unsaturated carboxylic acid or a derivative thereof (e.g., acid anhydride, ester, etc.) to the aforementioned unmodified hydrogenated block copolymer.

The proportion of mass increase because of the grafting or adding is not particularly limited, and is preferably 0.01% by mass or more with respect to 100% by mass of the unmodified hydrogenated block copolymer. In addition, the proportion is preferably 10% by mass or less, more preferably 7% by mass or less, and particularly preferably 5% by mass or less, with respect to 100% by mass of the unmodified hydrogenated block copolymer, without being limited thereto.

The method of producing the modified hydrogenated block copolymer is not particularly limited, and examples thereof include a method of reacting the aforementioned unmodified hydrogenated block copolymer with an α,β-unsaturated carboxylic acid or a derivative thereof at 80° C. to 350° C. in a molten, solution or slurry state in the presence or absence of a radical generator.

(d) Fibrous Inorganic Filler

The (d) fibrous inorganic filler optionally used in the present embodiment is not limited in its shape, and any known fibrous inorganic filler may be used. In addition, the component (d) to be used is preferably one that has been subjected to a surface treatment, for example, a treatment with various coupling agents such as silane-based ones and titanate-based ones, or various sizing agents such as epoxy resins and urethane resins.

Examples of the (d) fibrous inorganic filler include glass fibers, carbon fibers, whiskers such as potassium titanate, and wollastonite. It is preferable to contain glass fibers among the above. Furthermore, the average diameter of the fiber is 3 μm to 20 μm and more preferably 5 μm to 20 μm in consideration of the reinforcing effect of the fibrous inorganic filler.

(e) Thermoplastic Resin Other than Components (a) to (c)

The resin composition contained in a molded product of the present embodiment can further contain (e) a thermoplastic resin other than the components (a) and (b) as a resin component other than the components (a) to (c). The component (e) is not particularly limited, and examples thereof include a hydrogenated block copolymer other than the component (c), an olefin elastomer, polystyrene, syndiotactic polystyrene, high-impact polystyrene, polyamide, polyphenylene sulfide, and a fluorine polymer.

(x) Additive Other than Components (a) to (e)

The resin composition contained in a molded product of the present embodiment can further contain (x) an additive other than the components (a) to (e) as an additive component other than the components (a) to (d). The component (x) is not particularly limited, and examples thereof include an antioxidant, a metal deactivator, a heat stabilizer, a flame retardant (a phosphinate, a phosphate ester compound, an ammonium pyrophosphate compound, an ammonium polyphosphate compound, magnesium hydroxide, an aromatic halogen flame retardant, a silicone flame retardant, zinc borate, etc.), a plasticizer (low-molecular weight polyethylene, epoxidized soybean oil, polyethylene glycol, fatty acid esters, etc.), a flame retardant aid such as antimony trioxide, a weather (light) resistance improver, a crystal nucleating agent for polyolefin, a slip agent, an inorganic or organic filler material or reinforcement material other than the component (d) (carbon black, titanium oxide, calcium carbonate, talc, kaolin, glass flake, conductive carbon black, etc.), and various coloring agents and mold release agents

Content of Each Component

The following describes the content of each component of the resin composition of the present embodiment.

The content of the component (a) in the resin composition of the present embodiment is preferably 50% by mass or more, more preferably 55% by mass or more, still more preferably 60% by mass or more, and particularly preferably 65% by mass or more, with respect to a total of 100% by mass of the components (a) to (c). In addition, the content is preferably 99% by mass or less, more preferably 80% by mass or less, and still more preferably 75% by mass or less. When the content is in the aforementioned ranges, it is easier to maintain a high storage elastic modulus for the resin composition after water absorption. In addition, it is possible to balance the impact resistance and the molding fluidity.

The content of the component (b) in the resin composition of the present embodiment is preferably 1% by mass or more, more preferably 20% by mass or more, and still more preferably 25% by mass or more, with respect to a total of 100% by mass of the components (a) to (c). In addition, the content is preferably 50% by mass or less, more preferably 40% by mass or less, still more preferably 35% by mass or less, and particularly preferably 30% by mass or less. When the content is in the aforementioned ranges, it is easier to maintain a high storage elastic modulus for the resin composition after water absorption. In addition, it is possible to balance the impact resistance and the molding fluidity.

From the viewpoint of maintaining a high storage elastic modulus for the resin composition after water absorption, the content of the component (c) in the resin composition of the present embodiment is preferably 2% by mass or more, more preferably 3% by mass or more, and still more preferably 5% by mass or more, with respect to a total of 100% by mass of the components (a) to (c). In addition, from the viewpoint of suppressing the peeling from a molded piece and obtaining a favorable external appearance, the content is preferably 20 parts by mass or less and more preferably 15 parts by mass or less.

The content of each of the component (d) and the component (x) in the resin composition of the present embodiment is not particularly limited as long as the effects of the present disclosure are not impaired. For example, the content may be 0 to 400 parts by mass with respect to a total of 100 parts by mass of the components (a) to (c). The upper limit of the content of each of the component (d) and the component (x) may be 50 parts by mass, 10 parts by mass, 5 parts by mass, or 1 part by mass, for example.

In addition, the content of the component (e) is not particularly limited as long as the effects of the present disclosure are not impaired. The content is preferably 0 to 50 parts by mass with respect to a total of 100 parts by mass of the components (a) to (c). The upper limit of the content of the component (e) may be 4 parts by mass, 3 parts by mass, 2 parts by mass, or 1 part by mass, for example. The content is preferably 0 to 50 parts by mass from the viewpoint of suitably achieving the effects of the present embodiment.

Property of Resin Composition

The resin composition of the present embodiment has a deflection temperature under load of 100° C. or higher, preferably 105° C. or higher, and more preferably 110° C., at 0.45 MPa, which is measured according to ISO 75. Because the deflection temperature under load is 100° C. or higher, it can also be suitably used in a relay box housing set in a sealed car in summer with a deflection temperature under load of 100° C. or higher, for example. Examples of the method of adjusting the deflection temperature under load include a method of adjusting the crystallinity of the component (a) to be used by molecular weight or use of a crystal nucleating agent, a method of adjusting the addition amounts of the component (a) and the component (b), and a method of adjusting the addition amount of the crystal nucleating agent which can be previously contained in the component (a).

In addition, in a case where multipurpose test specimens as defined in ISO 294-1, which are obtained from the resin composition with an injection molding method, are processed under the following conditions to obtain test specimens A and B, and storage elastic modulus measurement is performed on each of the test specimens A and B at 50° C. in a tensile mode to obtain storage elastic moduli G′_{A} and G′_{B}, a ratio of the storage elastic modulus G′_{A} to G′_{B} (G′_{A}/G′_{B}) is 0.9 to 1.5 and preferably 0.95 to 1.50.

Test specimen A: the multipurpose test specimen is annealed at 80° C. for 24 hours after injection molding and immersed in water at 70° C. for 12 hours after annealing, and then the test specimen after immersing is left to stand for 672 hours in an environment of 23° C. and 50% RH. The test specimen after standing is used as the test specimen A, and the storage elastic modulus G′_{A} is measured at 50° C. in a tensile mode.

Test specimen B: the multipurpose test specimen is annealed at 80° C. for 24 hours after injection molding. The test specimen after annealing is used as the test specimen B, and the storage elastic modulus G′_{B} is measured at 50° C. in a tensile mode.

When the ratio of the storage elastic modulus G′_{A} to G′_{B} (G′_{A}/G′_{B}) is 0.9 or more, it is possible to suppress the decrease in toughness in an actual use environment. In addition, when the ratio is 1.5 or less, it is possible to suppress the decrease in rigidity in an actual use environment.

In the present embodiment, the method of controlling the ratio of the storage elastic modulus G′_{A} to G′_{B} (G′_{A}/G′_{B}) to the aforementioned ranges is not particularly limited, and examples thereof include a method of adjusting the addition amounts of the component (a) and the component (b), and a method of adjusting the addition amount of the crystal nucleating agent which can be previously contained in the component (a).

Furthermore, from the viewpoint of improving the heat resistance, suppressing the dimensional change upon water absorption, and enhancing the vibration fatigue strength, the crystallization peak area measured by a differential scanning calorimeter (DSC) is preferably 55 J/g or more and more preferably 60 J/g. The upper limit of the crystallization peak area is not particularly limited, and may be, for example, 100 J/g, and more specifically, 80 J/g.

Examples of the method of controlling the crystallization peak area in the aforementioned ranges include a method of decreasing the molecular weight of the polypropylene (increasing the MFR), a method of adding a crystal nucleating material for the polypropylene, a method of increasing the total vinyl bond content of the component (c), and a method of reducing the addition amount of additives that inhibit the crystallization of the polypropylene such as a flame retardant.

Morphology of Resin Composition

For the morphology of the resin composition of the present embodiment, it is preferable that the component (a) is in a continuous phase and the component (b) is in a dispersed phase, and that the average major axis of the component (b) dispersed as a dispersed phase is 1 μm or less, from the viewpoint of further suppressing the changes in physical properties and in dimensions upon water absorption.

In the present disclosure, the morphology of the resin composition can be observed using, for example, a TEM (transmission electron microscope). Specifically, an ultra-thin section cut out of a molded product of the resin composition is stained with ruthenium tetroxide and then observed at a magnification of about 10,000×. The component (a) can be observed relatively brightly as compared with the component (b) when the ultrathin section is stained with ruthenium tetroxide. Subsequently, the average major axis can be determined by measuring the major axis of at least 100 randomly selected dispersed phases and calculating their average.

The morphology of the resin composition can be adjusted, for example, by adjusting the amount of the component (a) in the entire composition, or appropriately selecting the molecular weight of the polymer block A and the microstructure of the polymer block B contained in the component (c).

Method of Producing Resin Composition

The resin composition of the present embodiment can be produced by melt-kneading the aforementioned components (a) to (c) and, if necessary, the components (d) and (x).

The method of producing the resin composition of the present embodiment is not particularly limited. For example, the resin composition can be produced by melt-kneading the components (a) to (c) and, if necessary, the component (d), component (e) and component (x). More specifically, the method of producing the resin composition of the present embodiment is preferably the following production method.

That is, the method of producing the resin composition of the present embodiment includes:

a step (1-1) of melt-kneading all of the component (b), and all or a part of the components (a) and (c) to obtain a kneaded material; and

a step (1-2) of adding the rest of the components (a) and (c) to the kneaded material obtained in the step (1-1) (except the case where all of the components (a) and (c) are used in the step (1-1)), and further melt kneading them to obtain a kneaded material.

The melt-kneader suitably used for melt-kneading each component in the aforementioned production method is not particularly limited. Examples thereof include a heating and melting kneader such as an extruder, a roll, a kneader, a Brabender plastograph and a Banbury mixer. Examples of the extruder include a single-screw extruder and a multi-screw extruder such as a twin-screw extruder. In particular, a twin-screw extruder is preferable from the viewpoint of kneadability. Specific examples of the twin-screw extruder include ZSK series made by Coperion Inc., TEM series made by Toshiba Machine Co., Ltd., and TEX series made by the Japan Steel Works, Ltd.

The following describes a preferable embodiment where an extruder such as a single-screw extruder or a multi-screw extruder such as a twin-screw extruder is used.

The type and standard of the extruder is not particularly limited, and any known extruder may be used.

The L/D (effective barrel length/barrel internal diameter) of the extruder is preferably 20 or more and more preferably 30 or more. In addition, the L/D is preferably 75 or less and more preferably 60 or less.

The configuration of the extruder is not particularly limited. For example, the extruder may be one including a first raw material supply port provided at the upstream side of the raw material flowing direction, a first vacuum vent provided downstream of the first raw material supply port, second and third raw material supply ports provided downstream of the first vacuum vent, and a second vacuum vent provided downstream of these raw material supply ports.

Furthermore, the method of supplying raw materials at the second and third raw material supply ports is not particularly limited, and it may be a method of simply adding raw materials from an upper opening of each raw material supply port or a method of adding raw materials using a forced side feeder from a side opening. In particular, it is preferably a method of adding raw materials using a forced side feeder from a side opening, from the viewpoint of stable supplying.

When melt-kneading the components, the melt-kneading temperature is not particularly limited and may usually be 200° C. to 370° C., and the screw speed is not particularly limited and may usually be 100 rpm to 1,200 rpm.

In the case of adding a liquid raw material, the liquid raw material may be added by feeding the same directly into the cylinder system using a tubing pump or the like in the cylinder portion of the extruder. The tubing pump is not particularly limited, and examples thereof include a gear pump and a flange-type pump, among which a gear pump is preferable. In this case, from the viewpoint of reducing the load on the tubing pump and improving the operability of the raw material, it is preferable to heat a tank for storing the liquid raw material, a pipe between the tank and the tubing pump, and a flow path of the liquid raw material such as a pipe between the pump and the extruder cylinder with a heater to reduce the viscosity of the liquid raw material.

(Method of Producing Relay Box Housing)

The relay box housing of the present embodiment can be produced by molding the resin composition of the present embodiment described above.

The method of producing the molded product of the present embodiment is not particularly limited, and examples thereof include injection molding, extrusion molding, extrusion deformation molding, hollow molding, and compression molding, among which injection molding is preferable from the viewpoint of achieving the effects of the present disclosure more effectively.

### EXAMPLE S

The following describes the embodiment of the present disclosure based on Examples. However, the present disclosure is not limited to these Examples.

The raw materials used in the resin compositions of Examples and Comparative Examples are as follows.

(a) Polypropylene Resin

(a-i): a polypropylene homopolymer having a MFR of 115 g/10 min and containing 0.2% by mass of “ADEKASTAB NA-11” made by ADEKA Corporation as a crystal nucleating agent

(a-ii): a polypropylene homopolymer having a MFR of 35 g/10 min and containing 0.2% by mass of “ADEKASTAB NA-11” made by ADEKA Corporation as a crystal nucleating agent

(a-iii): a polypropylene homopolymer having a MFR of 3.5 g/10 min

(a-iv): a polypropylene homopolymer having a MFR of 35 g/10 min

(a-v): a polypropylene homopolymer having a MFR of 6 g/10 min

The MFR was measured under the conditions of a temperature of 230° C. and a load of 2.16 kg according to ISO 1133.

(b) Polyphenylene Ether Resin

(b-i) polyphenylene ether having a reduced viscosity of 0.50 (ηsp/c: 0.5 g/dL chloroform solution) obtained by oxidative polymerization of 2, 6-xylenol

(b-ii) polyphenylene ether having a reduced viscosity of 0.33 (ηsp/c: 0.5 g/dL chloroform solution) obtained by oxidative polymerization of 2, 6-xylenol

The reduced viscosity was measured at a temperature of 30° C. using a chloroform solution of ηsp/c : 0.5 g/dL.

(c) Hydrogenated Block Copolymer

Block copolymers having a block structure were synthesized with a known method, where the polymer block A was made of polystyrene and the polymer block B was made of polybutadiene. Hydrogenation was performed on the synthesized block copolymers with a known method. Modification of polymer was not performed. The physical properties of the obtained unmodified hydrogenated block copolymers were as follows.

(c-i) B-A-B-A Type

The content of polystyrene in the block copolymer before hydrogenation was 40%; the number-average molecular weight (Mn) of the block copolymer before hydrogenation was 140,000; the number-average molecular weight (Mn) of the polystyrene block was 32,000; the number-average molecular weight (Mn) of the polybutadiene block was 76,000; the molecular weight distribution (Mw/Mn) of the block copolymer before hydrogenation was 1.7; the total vinyl bond content (the total of 1,2-vinyl bond content and 3,4-vinyl bond content) in the polybutadiene block before hydrogenation was 70%; and the hydrogenation ratio with respect to the polybutadiene moiety of the polybutadiene block was 99.9%.

(c-ii) A-B-A Type

The content of polystyrene in the block copolymer before hydrogenation was 65%; the number-average molecular weight (Mn) of the block copolymer before hydrogenation was 53,500; the number-average molecular weight (Mn) per polystyrene block was 17,400; the number-average molecular weight (Mn) of the polybutadiene block was 18,700; the molecular weight distribution (Mw/Mn) of the block copolymer before hydrogenation was 1.23; the total vinyl bond content (the total of 1,2-vinyl bond content and 3,4-vinyl bond content) in the polybutadiene block before hydrogenation was 25%; and the hydrogenation ratio with respect to the polybutadiene moiety of the polybutadiene block was 99.9%.

(c-iii) A-B-A Type

The content of polystyrene in the block copolymer before hydrogenation was 50%; the number-average molecular weight (Mn) of the block copolymer before hydrogenation was 120,000; the number-average molecular weight (Mn) per polystyrene block was 30,000; the number-average molecular weight (Mn) of the polybutadiene block was 60,000; the molecular weight distribution (Mw/Mn) of the block copolymer before hydrogenation was 1.35; the total vinyl bond content (the 1,2-vinyl bond content) in the polybutadiene block before hydrogenation was 95%; and the hydrogenation ratio with respect to the polybutadiene moiety of the polybutadiene block was 99.9%.

(c-iv)

The content of polystyrene in the block copolymer before hydrogenation was 33%; the number-average molecular weight (Mn) of the block copolymer before hydrogenation was 246,000; the number-average molecular weight (Mn) of the polystyrene block was 20,300; the number-average molecular weight (Mn) of the polybutadiene block was 164,800; the molecular weight distribution (Mw/Mn) of the block copolymer before hydrogenation was 1.09; the total vinyl bond content (the 1,2-vinyl bond content) in the polybutadiene block before hydrogenation was 33%; and the hydrogenation ratio with respect to the polybutadiene moiety of the polybutadiene block was 99.9%.

The content of the vinyl aromatic compound was measured with a UV spectrophotometer. The number-average molecular weight (Mn) was determined with a conventionally known method using GPC (moving bed: chloroform, standard substance: polystyrene). The molecular weight distribution (Mw/Mn) was calculated by dividing the weight-average molecular weight (Mw), which was determined with a conventionally known method using GPC (moving bed: chloroform, standard substance: polystyrene), by the aforementioned number-average molecular weight (Mn). The total vinyl bond content was measured using an infrared spectrophotometer and calculated according to the method described in Analytical Chemistry, Volume 21, No. 8, August, 1949. The hydrogenation ratio was measured using a nuclear magnetic resonance (NMR) apparatus.

(d) Fibrous Inorganic Filler

Glass fiber with an average fiber diameter of 13 μm surface-treated with an aminosilane compound (product name: ECS03T-480, made by Nippon Electric Glass Co., Ltd.).

### Other Components Used in Comparative Examples

Polyamide 6,6

Viscosity number=120 mL/g (according to ISO 307, 96% sulfuric acid)

Terminal amino group concentration=3×10⁵ mol/g

Terminal carboxyl group concentration=1.1×10⁶ mol/g

Maleic Anhydride (MAH)

Maleic anhydride made by Wako Pure Chemical Industries, Ltd.

Zinc Sulfide

Product name “Sachtolith HD”, made by Sachtleben

Flame Retardant

“Exolit® (Exolit is a registered trademark in Japan, other countries, or both) OP 1312” made by Clariant (a mixture containing an aluminum salt of phosphinic acid)

The following describes the measuring methods (1) to (3) and evaluation methods (4) to (6) of the physical properties of the resin compositions obtained in Examples and Comparative Examples.

(1) Deflection Temperature Under Load

The obtained resin composition pellet was subjected to an injection molding machine (IS-100GN made by Toshiba Machine Co., Ltd.), where the cylinder temperature was set to 250° C. and the mold temperature was set to 70° C., to obtain a JIS K7139 A multipurpose test specimen. The obtained test specimen was annealed at 80° C. for 24 hours. Subsequently, a test specimen was further cut out from the multipurpose test specimen, and the test specimen was evaluated by the flatwise method under the condition of 0.45 MPa according to ISO 75.

(2) Measurement of Crystallization Peak Area

The obtained resin composition pellet was measured by the following temperature program using Diamond DSC made by PerkinElmer. The area of the crystallization peak observed in Step 3 (temperature lowering process) of the temperature program was calculated as the energy value in J/g per sample unit mass.

Step 1: raising the temperature from 50° C. to 300° C. at 100° C./min

Step 2: keeping the temperature at 300° C. for one minute

Step 3: lowing the temperature from 300° C. to 100° C. at 5° C./min

(3) Measurement of Storage Elastic Modulus Before and After Water Absorption

The obtained resin composition pellet was subjected to an injection molding machine (IS-100GN made by Toshiba Machine Co., Ltd.), where the cylinder temperature was set to 250° C. and the mold temperature was set to 70° C., to obtain a JIS K7139 A multipurpose test specimen. The molded test specimen was annealed in an environment of 80° C. for 24 hours, and the annealed test specimen was used as a sample before water absorption (a test specimen B) and the storage elastic modulus thereof was measured. In addition, the molded test specimen was annealed in an environment of 80° C. for 24 hours, then immersed in water at 70° C. for 12 hours, and then adjusted in an environment of 23° C. and 50% RH for 672 hours. The adjusted test specimen was used as a sample after water absorption (a test specimen A). Each of the test specimens A and B prepared in this manner was subjected to storage elastic modulus measurement using the viscoelasticity measuring apparatus RSA-III made by TA Instruments in a tensile mode, where the frequency was 1 Hz, the measurement temperature range was −30° C. to 160° C., and the heating rate was 3° C./min. In this case, the ratio G′_{A}/G′_{B} of the storage elastic modulus G′_{A} at 50° C. after water absorption and the storage elastic modulus G′_{B} before water absorption was calculated.

(4) Vibration Fatigue Properties

The obtained resin composition pellet was subjected to an injection molding machine (IS-100GN made by Toshiba Machine Co., Ltd.), where the cylinder temperature was set to 250° C. and the mold temperature was set to 70° C., to obtain a test specimen according to JIS K7119 III (ASTM D671 TYPE A). The obtained test specimen was set in a B70 bending vibration fatigue tester made by Toyo Seiki Co., Ltd. to measure the vibration fatigue strength under the conditions of a temperature of 23° C., a load of 40 MPa, and a frequency of 1800 times per minute. This evaluation was taken as an evaluation of the durability when the resin composition was molded into a box and actually used. That is to say, the composition having a greater number of times until it breaks or becomes inelastic (stretches to its full length) in the vibration fatigue test results in improved durability.

Note that in the present test, “becoming inelastic” means that the amplitude is ±8 mm or more.

(5) Dimensional Change Upon Water Absorption

The obtained resin composition pellet was subjected to an injection molding machine (IS-100GN made by Toshiba Machine Co., Ltd.), where the cylinder temperature was set to 250° C. and the mold temperature was set to 70° C., to obtain a molded product in the shape illustrated in FIG. 1 (a substitute for a relay box housing; the thickness of the molded product was 2 mm). After molding, the molded product was immersed in water at 80° C. and allowed to stand for 12 hours, and then taken out and further adjusted in an environment of 23° C. and 50% RH for 168 hours. With respect to the length in the longitudinal direction of the molded product, the ratio L_{A}/L_{B} of the two dimensions was calculated, where the length immediately after molding was L_{B} and the length after water absorption and adjustment was L_{A}.

(6) Warpage of Molded Piece

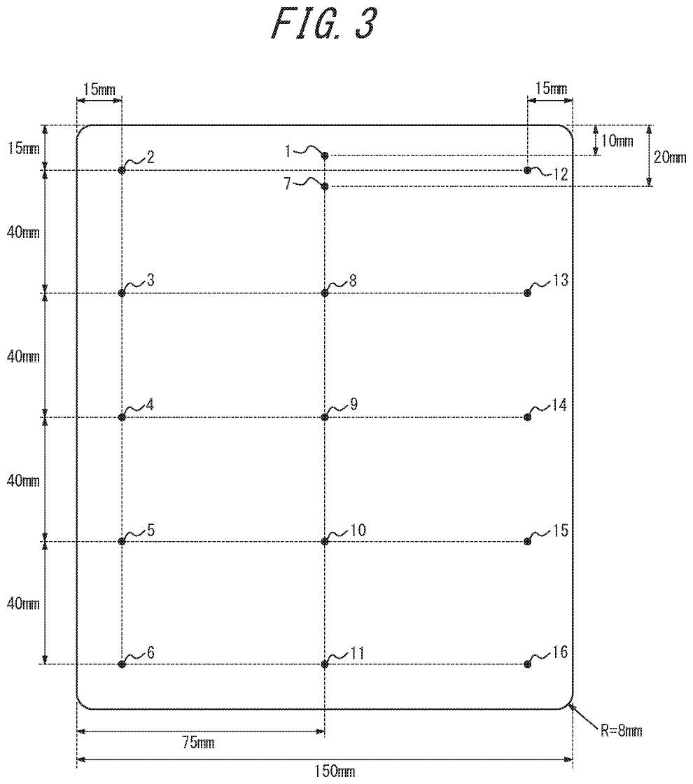

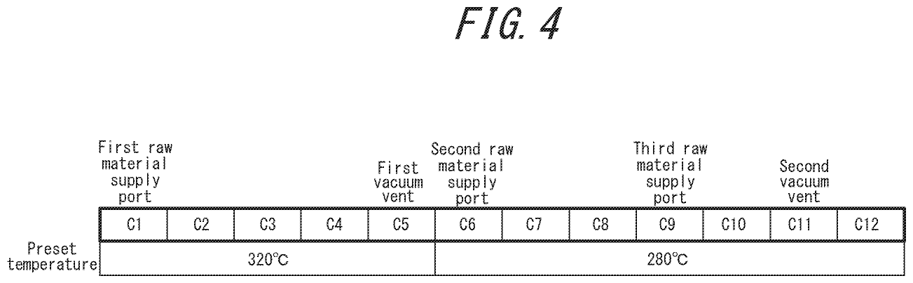

Pellets of the resin compositions obtained in Examples and Comparative Examples were supplied to a screw inline-type injection molding machine where the temperature was set to 240° C. to 280° C., and injection molding was performed at a mold temperature of 60° C. to obtain 150×150×2 mm (2mm in thickness) flat plates. For each flat plate, a virtual plane was set with the 15 points illustrated in FIG. 3 by the least squares method using a three-dimensional measuring instrument made by Mitutoyo Corporation, and a value obtained by subtracting the minimum value from the maximum value of the deviation of the plane was taken as the flatness of the flat plate. A smaller value indicates less warpage in the molded piece.

The following describes each Example and Comparative Example in detail.

### Examples 1 to 11 and Comparative Examples 1 to 9

A twin-screw extruder (ZSK-25 made by Coperion) was used as a melt-kneader used for producing the resin composition. The L/D of the extruder was 35.

The configuration of the twin-screw extruder was as illustrated in FIG. 4, where a first raw material supply port was provided at the upstream side of the raw material flowing direction, second and third raw material supply ports were provided downstream of the first raw material supply port, and a vacuum vent was provided between the first raw material supply port and the second raw material supply port and between the third raw material supply port and a die head.

In addition, the method of supplying raw materials in the second and third raw material supply ports was a method of adding raw materials using a forced side feeder from a side opening.

Then, the components (a) to (d) were supplied in the composition listed in Table 1 to the twin-screw extruder set as described above, and these components were melt-kneaded to produce pellet resin compositions. The kneading conditions were as follows: the extruder barrel temperature (from the first raw material supply port to the second raw material supply port) was 320° C., the extruder barrel temperature (from the second raw material supply port to the die head) was 320° C., the screw speed was 300 rpm, and the discharge amount was 15 kg/hour.

A physical property test was conducted on each of the Examples and the Comparative Examples with the aforementioned measurement methods (1) to (6). The results are listed in Tables 1 and 2.

TABLE 1

| | | | | Exam- | Exam- | Exam- | Exam- | Exam- | Exam- | Exam- | Exam- | Exam- | Exam- | Exam- |
|---|---|---|---|---|---|---|---|---|---|---|---|---|---|---|
| | | | | ple 1 | ple 2 | ple 3 | ple 4 | ple 5 | ple 6 | ple 7 | ple 8 | ple 9 | ple 10 | ple 11 |
| Method of | First raw | Component (a-i) | Parts by mass | 22 | | | | 18 | | | 25 | 22 | 19 | 22 |
| producing resin | material supply | Component (a-ii) | Parts by mass | | 22 | | | | 18 | | | | | |
| composition | port | Component (a-iii) | Parts by mass | | | 22 | | | | | | | | |
| | | Component (a-iv) | Parts by mass | | | | 22 | | | 18 | | | | |
| | | Component (b-i) | Parts by mass | 28 | 28 | 28 | 28 | 36 | 36 | 36 | 20 | 28 | 25 | 28 |
| | | Component (c-i) | Parts by mass | 7 | 7 | 7 | 7 | 8 | 8 | 8 | 5 | | 6 | 7 |
| | | Component (c-ii) | Parts by mass | | | | | | | | | | | |
| | | Component (c-iii) | Parts by mass | | | | | | | | | 7 | | |
| | Second raw | Component (a-i) | Parts by mass | 43 | | | | 38 | | | 50 | 43 | 50 | 43 |
| | material supply | Component (a-ii) | Parts by mass | | 43 | | | | 38 | | | | | |
| | port | Component (a-iii) | Parts by mass | | | 43 | | | | | | | | |
| | | Component (a-iv) | Parts by mass | | | | 43 | | | 38 | | | | |
| | Third raw | Component (d) | Parts by mass | | | | | | | | | | 30 | 30 |
| | material supply | | | | | | | | | | | | | |
| | port | | | | | | | | | | | | | |

| Composition | Component (a) | Mass % | 65 | 65 | 65 | 65 | 56 | 56 | 56 | 75 | 65 | 69 | 65 |
|---|---|---|---|---|---|---|---|---|---|---|---|---|---|
| of resin | Component (b) | Mass % | 28 | 28 | 28 | 28 | 36 | 36 | 36 | 20 | 28 | 25 | 28 |
| comnosition | Component (c) | Mass % | 7 | 7 | 7 | 7 | 8 | 8 | 8 | 5 | 7 | 6 | 7 |
| Morphology | Morphology where the component (a) is a continuous phase and | | Good | Good | Good | Good | Good | Good | Good | Good | Poor | Good | Good |
| | the component (b) is a dispersed phase, and the average major axis of | | | | | | | | | | | | |
| | the dispersed phase of the component (b) is 1 μm or less | | | | | | | | | | | | |
| Physical | (1) Deflection temperature | ° C. | 120 | 110 | 101 | 106 | 113 | 105 | 100 | 103 | 115 | 152 | 155 |
| properties | under load | | | | | | | | | | | | |
| of resin | (2) Crystallization peak | J/g | 72.0 | 68.2 | 66.7 | 68.6 | 77.3 | 72.9 | 70.3 | 75.3 | 67.8 | 56.2 | 52.8 |
| composition | area | | | | | | | | | | | | |
| | (3) Ratio of storage elastic | — | 0.99 | 0.99 | 0.98 | 0.98 | 0.98 | 0.97 | 0.98 | 0.99 | 0.97 | 0.97 | 0.96 |
| | modulus before and after water | | | | | | | | | | | | |
| | absorption G′_{A}/G′_{B} | | | | | | | | | | | | |
| Evaluation | (4) Vibration fatigue | Ten thousand | 52.9 | 51.8 | 47.7 | 49.2 | 55.6 | 53.2 | 50.4 | 50.2 | 45.3 | 74.9 | 73.2 |
| | properties | times | | | | | | | | | | | |
| | (5) Dimensional change | — | 1.00 | 1.00 | 1.00 | 1.00 | 1.00 | 1.00 | 1.00 | 1.00 | 1.00 | 1.00 | 1.00 |
| | upon water absorption L_{A}/L_{B} | | | | | | | | | | | | |
| | (6) Warpage of molded | mm | 1.08 | 1.05 | 0.99 | 1.02 | 0.92 | 0.90 | 0.88 | 1.12 | 1.22 | 4.51 | 4.26 |
| | piece | | | | | | | | | | | | |

TABLE 2

| | | | | Compar- | Compar- | Compar- | Compar- | Compar- | Compar- | Compar- | Compar- | Compar- |
|---|---|---|---|---|---|---|---|---|---|---|---|---|
| | | | | ative | ative | ative | ative | ative | ative | ative | ative | ative |
| | | | | Exam- | Exam- | Exam- | Exam- | Exam- | Exam- | Exam- | Exam- | Exam- |
| | | | | ple 1 | ple 2 | ple 3 | ple 4 | ple 5 | ple 6 | ple 7 | ple 8 | ple 9 |
| Method of | First raw | Component (a-i) | Parts by mass | 22 | | | | | 29 | 30 | | |
| producing resin | material supply | Component (a-ii) | Parts by mass | | 22 | | | | | | | |
| composition | port | Component (a-iii) | Parts by mass | | | 22 | | 18 | | | | |
| | | Component (a-iv) | Parts by mass | | | | 22 | | | | | |
| | | Component (a-v) | Parts by mass | | | | | | | | 10 | 100 |
| | | Component (b-i) | Parts by mass | 28 | 28 | 28 | 28 | 36 | 10 | | | |
| | | Component (b-ii) | Parts by mass | | | | | | | | 40 | |
| | | Component (c-i) | Parts by mass | | | | | 8 | 3 | | 10 | |
| | | Component (c-ii) | Parts by mass | 7 | 7 | 7 | 7 | | | | | |
| | | Component (c-iii) | Parts by mass | | | | | | | | | |
| | | Component (c-iv) | Parts by mass | | | | | | | 7 | | |
| | | Maleic anhydride | Parts by mass | | | | | | | 0.2 | | |
| | | Zinc sulfide | Parts by mass | | | | | | | | 3 | |
| | Second raw | Component (a-i) | Parts by mass | 43 | | | | | 58 | | | |
| | material supply | Component (a-ii) | Parts by mass | | 43 | | | | | | | |
| | port | Component (a-iii) | Parts by mass | | | 43 | | 38 | | | | |
| | | Component (a-iv) | Parts by mass | | | | 43 | | | | | |
| | | Component (a-v) | Parts by mass | | | | | | | | 50 | |
| | | Polyamide 6,6 | Parts by mass | | | | | | | 63 | | |
| | Third raw | Component (d) | Parts by mass | | | | | | | | | |
| | material supply | Flame retardant | Parts by mass | | | | | | | | 26 | |
| | port | | | | | | | | | | | |

| Composition | Component (a) | Mass % | 65 | 65 | 65 | 65 | 56 | 87 | 81 | 55 | 100 |
|---|---|---|---|---|---|---|---|---|---|---|---|
| of resin | Component (b) | Mass % | 28 | 28 | 28 | 28 | 36 | 10 | 0 | 36 | 0 |
| composition | Component (c) | Mass % | 7 | 7 | 7 | 7 | 8 | 3 | 19 | 9 | 0 |
| Morphology | Morphology where the component (a) is a continuous phase and | | Poor | Poor | Poor | Poor | Good | Poor | — | Poor | — |
| | the component (b) is a dispersed phase, and the average major axis of | | | | | | | | | | |
| | the dispersed phase of the component (b) is 1 μm or less | | | | | | | | | | |
| Physical | (1) Deflection temperature | ° C. | 99 | 97 | 95 | 96 | 95 | 92 | 175 | 99 | 89 |
| properties | under load | | | | | | | | | | |
| of resin | (2) Crystallization peak | J/g | 60.7 | 56.3 | 51.1 | 54.8 | 67.2 | 75.9 | 41.8 | 50.4 | 94.2 |
| composition | area | | | | | | | | | | |
| | (3) Ratio of storage elastic | — | 0.96 | 0.95 | 0.93 | 0.94 | 0.98 | 0.98 | 0.62 | 0.91 | 1.01 |
| | modulus before and after | | | | | | | | | | |
| | water absorption G′_{A}/G′_{B} | | | | | | | | | | |
| Evaluation | (4) Vibration fatigue | Ten thousand | 31.5 | 27.9 | 24.8 | 26.4 | 49.5 | 58.3 | 45.3 | 38.5 | 16.2 |
| | properties | times | | | | | | | | | |
| | (5) Dimensional change | — | 1.00 | 1.00 | 1.00 | 1.00 | 1.00 | 1.00 | 1.02 | 1.03 | 1.00 |
| | upon water absorption L_{A}/L_{B} | | | | | | | | | | |
| | (6) Warpage of molded | mm | 1.56 | 1.53 | 1.47 | 1.51 | 0.86 | 1.81 | 1.77 | 1.38 | 1.97 |
| | piece | | | | | | | | | | |

As listed in Tables 1 and 2, the resin compositions of Examples 1 to 11 are superior to the resin compositions of Comparative Examples 1 to 9 in heat resistance and vibration fatigue properties. Therefore, it can be understood that when the resin composition of the present disclosure is molded into a relay box housing and used, the change in such properties caused by the surrounding environment change is relatively small.

### INDUSTRIAL APPLICABILITY

According to the present disclosure, it is possible to provide a relay box housing that has excellent durability against vibration during actual use which is also capable of maintaining heat resistance. The relay box of the present disclosure is particularly suitably used as, for example, a relay box housing for motor vehicles.

1. A relay box housing obtained by molding a resin composition, wherein
the resin composition comprises:
(a) a polypropylene resin,
(b) a polyphenylene ether resin, and
(c) a hydrogenated block copolymer in which at least a part of a block copolymer comprising a polymer block A and a polymer block B is hydrogenated, where the polymer block A is a block mainly composed of a vinyl aromatic compound, and the polymer block B is a block mainly composed of a conjugated diene compound having a total content of 1,2-vinyl bonds and 3,4-vinyl bonds of 30% to 90%, wherein
the resin composition has a deflection temperature under load of 100° C. or higher at 0.45 MPa as measured according to ISO 75, and
the resin composition has a ratio of the storage elastic modulus G′_{A} to G′_{B}, expressed as G′_{A}/G′_{B}, of 0.9 to 1.5, where G′_{A} and G′_{B} are storage elastic moduli of test specimens A and B, respectively, obtained by processing multipurpose test specimens as defined in ISO 294-1, which are obtained from the resin composition with an injection molding method, under a set of conditions, storage elastic modulus measurement is performed on each of the test specimens A and B at 50° C. in a tensile mode to obtain the storage elastic moduli G′_{A} and G′′_{B}, and the set of conditions are as follows:
test specimen A: a first multipurpose test specimen is annealed at 80° C. for 24 hours after injection molding and immersed in water at 70° C. for 12 hours after annealing, then the first multipurpose test specimen after immersing is left to stand in an environment of 23° C. and 50% RH for 672 hours, the first multipurpose test specimen, after standing, is used as the test specimen A, and the storage elastic modulus G′_{A} is measured at 50° C. in a tensile mode; and
test specimen B: a second multipurpose test specimen is annealed at 80° C. for 24 hours after injection molding, the second multipurpose test specimen, after annealing, is used as the test specimen B, and the storage elastic modulus G′_{B} is measured at 50° C. in a tensile mode.

2. The relay box housing according to claim 1, wherein a crystallization peak area of the resin composition measured by a differential scanning calorimeter (DSC) is 55 J/g or more.

3. The relay box housing according to claim 1, wherein the resin composition has a deflection temperature under load of 110° C. or higher at 0.45 MPa as measured according to ISO 75.

4. The relay box housing according to claim 2, wherein the resin composition has a deflection temperature under load of 110° C. or higher at 0.45 MPa as measured according to ISO 75.

5. The relay box housing according to claim 1, wherein the component (c) has a polystyrene-equivalent number-average molecular weight Mn of 150,000 or more as measured by gel permeation chromatography (GPC).

6. The relay box housing according to claim 1, wherein the resin composition has a morphology in which the component (a) is in a continuous phase and the component (b) is in a dispersed phase, and an average major axis of the dispersed phase of the component (b) is 1 μm or less.

7. The relay box housing according to claim 2, wherein the resin composition has a morphology in which the component (a) is in a continuous phase and the component (b) is in a dispersed phase, and an average major axis of the dispersed phase of the component (b) is 1 μm or less.

8. The relay box housing according to claim 4, wherein the resin composition has a morphology in which the component (a) is in a continuous phase and the component (b) is in a dispersed phase, and an average major axis of the dispersed phase of the component (b) is 1 μm or less.

9. The relay box housing according to claim 1, wherein the resin composition further comprises (d) fibrous inorganic filler.

10. The relay box housing according to claim 1, comprising a portion with a thickness of 0.5 mm to 5.0 mm.

11. A relay box comprising the relay box housing according to claim 1 and a relay block housed inside the relay box housing.
